(19) United States
(12) Patent Application Publication
(10) Pub. No.: US 2008/0280718 A1
(43) Pub. Date: Nov. 13, 2008

(54) Power-splitting hydromechanical continously variable transmission

(76) Inventor: Christian Pfaller, Eichstatt (DE)

Correspondence Address: Novak, Druce & Quigg LLP, 1300 I Street, N.W., Suite 1000, West Tower, WASHINGTON, DC, 20005, US

(21) Appl. No.: 12/003,351

(22) Filed: Dec. 21, 2007

(30) Foreign Application Priority Data
Dec. 22, 2006 (DE) 10 2006 061 116.0

(51) Int. Cl. F16H 47/04

(52) U.S. Cl. 475/83

(57) ABSTRACT

The invention relates to a power-splitting hydromechanical continuously variable transmission, particularly for motor vehicles, comprising an input shaft, which provides output to a summation gearbox mechanically on the one hand and via a hydrostatic pump unit, a volume control valve, and a hydraulic motor on the other hand, the summation gear, wherein the summation gearbox is a planetary gearbox, the gear elements of which are drivably connected at least to the input shaft, the hydraulic motor, and an output shaft. In order to achieve a transmission that is particularly advantageous from design and production points of view, the invention proposes to connect the hydrostatic pump unit by the one pump element to the input shaft and connect it mechanically by the other pump element to the one gear element of the summation gearbox

### CROSS-REFERENCE TO RELATED APPLICATIONS

This application claims priority from German Application No. 102006061116.0 filed Dec. 22, 2006, hereby incorporated be reference in its entirety.

The invention relates to a power-splitting hydromechanical continuously variable transmission, particularly for motor vehicles.

### BACKGROUND OF THE INVENTION

A transmission of this type is described, for example, in DE 36 22 045 C2, wherein in addition to the hydrostatic pump unit and a hydraulic motor two planetary gear sets as a summation gearbox and a starting clutch are provided in order to take the requirements, particularly for use in motor vehicles, into account.

It is the object of the invention to provide a power-splitting hydromechanical transmission, which in addition to the known advantages of a high spread of gear ratios and high power transfer is also designed particularly advantageously with respect to the configuration and production thereof.

### SUMMARY OF THE INVENTION

According to the invention, the hydrostatic pump unit comprising the one pump element having the input shaft and the other pump element is mechanically connected to the one gear element of the summation gearbox. This simple configuration enables fully variable power distribution between direct mechanical and hydromechanical on the summation gearbox, wherein the split power flows are united again with the applied gear ratio; in addition, the hydrostatic pump unit can be controlled as a starting clutch, thus eliminating a separate starting clutch.

In an advantageous manner with respect to production, the hydrostatic pump unit can be formed by a simple, encapsulated planetary gearbox, the planetary gears of which in interaction with the ring gear and the sun gear form gear pumps, wherein in the encapsulation intake and pressure ducts are configured, which communicate with the volume control valve. This results in a cost-effective, particularly robust and efficient pump unit.

The input shaft of the transmission preferably drives the sun gear of the planetary gearbox (as the one pump element) and the planet carrier having the planetary gears (as the other pump element) provides output to a gear element of the summation gearbox.

In an advantageous further development of the invention, also the hydraulic motor displaced axially adjacent to the pump unit can be configured as an encapsulated planetary gearbox, the planetary gears of which in interaction with the ring gear and the sun gear form gear pumps, wherein in the encapsulation pressure ducts communicating with the volume control valve and discharge ducts are provided.

Furthermore, in a particularly simple structural design and cost-efficient manner, the ring gear of the planetary gearbox configured as a hydraulic motor can be disposed non-rotatably, while the sun gear is drivably connected to the summation gearbox, and wherein in addition at least three planetary gears without planet carriers float between the ring gear and sun gear.

In a particularly advantageous embodiment regarding the gear ratios and the spread of gear ratios, the summation gearbox can be formed by a planetary gear set, comprising a ring gear, a sun gear and a planet carrier having a plurality of double planetary gears, of which in each case a radially inside planetary gear meshes with the sun gear and a radially outside planetary gear meshes with the ring gear.

In a structurally and constructively simple configuration, the planet carrier of the summation gearbox can be connected to the planet carrier of the hydrostatic pump unit via a first intermediate shaft.

Furthermore, the sun gear of the summation gearbox can be connected to the sun gear of the hydraulic motor via a hollow shaft about the first intermediate shaft, and finally the ring gear of the summation gearbox can be coupled to the output shaft.

In order to achieve advantageous and precise power-splitting control of the volume control valve, it is proposed to configure the pressure ducts of the hydrostatic pump unit such that they can be varied from completely open to completely closed, and that additionally the intake ducts of the pump unit can be bypassed with the pressure ducts thereof in order to interrupt a power transfer.

Furthermore, in order to provide an opposite direction of rotation of the output shaft (reverse gear or implementation of a slow-driving gear with gear ratios up to “infinite), the hydraulic motor can be driven in the opposite direction by reversing the volume flow, wherein in addition the planet carrier of the summation gearbox is stalled in order to achieve the reverse gear.

Finally, in a cost-efficient manner, the hydrostatic pump unit can at the same time operate the basic supply of the transmission with lubrication, cooling and the like in this way, a separate supply pump can be eliminated.

### BRIEF DESCRIPTION OF THE DRAWINGS

An exemplary embodiment of the invention will be explained in more detail hereinafter. The schematic illustration shows:

FIG. 1 a power-splitting hydromechanical continuously variable transmission for motor vehicles, comprising a hydrostatic pump unit, a volume control valve, a hydraulic motor, and a summation gearbox; and

FIG. 2 a view X according to FIG. 1 of the hydrostatic pump unit of the transmission.

### DETAILED DESCRIPTION OF EMBODIMENTS OF THE INVENTION

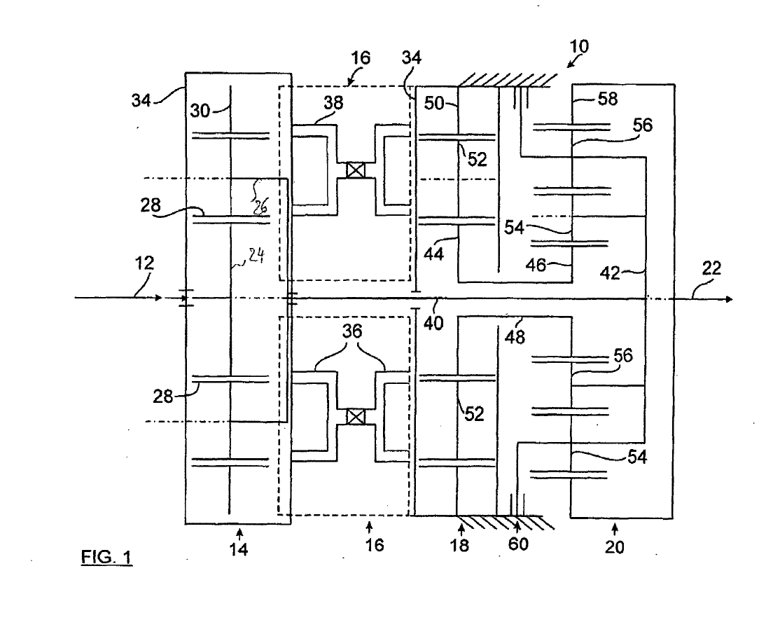

According to FIG. 1, the hydromechanical continuously variable transmission 10 for motor vehicle substantially comprises an input shaft 12, a hydrostatic pump unit 14, a volume control valve 16, a hydraulic motor 18, a summation gearbox 20, and an output shaft 22.

The drive power is introduced into the transmission 10 via the input shaft 12, which is coupled, for example, to an internal combustion engine, while the output shaft 22 is connected to the further drive system of the motor vehicle in the manner known to the person skilled in the art. The aforementioned gear elements 12, 14, 18 to 22 are mounted coaxially and rotatably in a transmission housing 30 in a manner that is not shown.

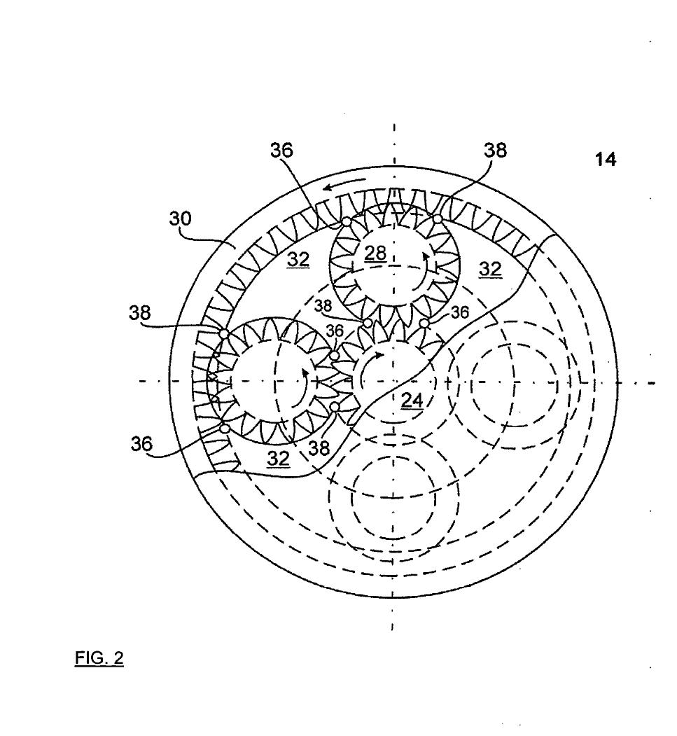

The hydrostatic pump unit 14 is substantially configured as a simple planetary gearbox comprising a sun gear 24, a planet carrier 26 having four rotatably mounted planetary gears 28 (see also FIG. 2), and a ring gear 30 (internal gear), wherein the teeth mutually engage each other. The planetary gearbox 14, however, is additionally configured as a gear pump by being provided with inside flow conducting bodies 32 (FIG. 2), an outer encapsulation 34 (FIG. 1) and corresponding seals (not shown), wherein the gear pump drives the hydraulic motor 18 by means of intake ducts 36 and pressure ducts 38 in a manner to be described hereinafter. As is apparent from FIG. 2, two intake ducts 36 and two pressure ducts 38 branch off each planetary gear 28, the ducts being united into a common intake chamber and pressure chamber in the volume control valve 16.

The sun gear 24, being the one (input) pump element of the pump unit 14, is coupled to the input shaft 12, while the planet carrier 26, being the other (output) pump element, is tightly connected to the planet carrier 42 of the summation gearbox 20 via a first intermediate shaft 40. The ring gear 30, being a free reaction member, “floats” on the planetary gears 2, 8.

The hydrostatic pump unit 14 is hydraulically connected to the hydraulic motor 18 via the intake ducts 36 and the pressure ducts 38. The hydraulic motor. 18, just like the pump unit 14, is configured as a gear pump or gear motor according to FIG. 2, having flow conducting bodies 32 and an encapsulation 34, and is driven by the pressurized volume flow of the pump unit 14 at an appropriately adjusted capacity.

As is apparent from FIG. 1, and deviating from FIG. 2, the outputting sun gear 44 of the hydraulic motor 14 is drivably connected to the sun gear 46 of the summation gearbox 20 via a hollow shaft 48, while the ring gear 50 of the hydraulic motor 18 is disposed stationary in the housing. The planetary gears 52 “float” between the ring gear 50 and the sun gear 44.

The summation gearbox 20 and/or the planet carriers 42 thereof carry a plurality of planetary gear sets having radially inner planetary gears 54 and radially outer planetary gears 56, which mesh with one another and with the sun gear 46 and the ring gear 58. The ring gear 58 is drivably coupled to the output shaft 22. The electrohydraulic volume control valve 16 (variable diaphragm), which is only indicated with dotted lines, is connected into the pressure ducts 38 and intake ducts 36 and is used to control the shifting states below.

The pressure and intake sides of the individual fluid pumps (formed by the elements of the planetary gearboxes 14, 18) are united in a common pressure and intake chamber. From there, the fluid flow reaches the hydraulic motor 18 via the volume control valve 16, which can be adjusted by an actuator system, which is not shown. A sensor (not illustrated) measures the prevailing fluid flow in the pressure chamber and reproduces the applied torque of the driving internal combustion engine.

Due to leakage losses in the gear pumps or gear motors, the fluid exchange expediently occurs on the intake chamber side. On the pressure chamber side, optionally the necessary fluid flows can be controlled in order to supply the transmission 10, particularly for the lubrication and cooling thereof.

If the volume control valve 16 is completely closed, the hydrostatic pump unit 14 and the hydraulic motor 18 are hydraulically blocked and the pump unit 14 thus transmits input power pure mechanically via the planet carrier 26 and the intermediate shaft 40 to the planet carrier 42 of the summation gearbox 20 and via the ring gear 58 thereof to the output shaft 22 (substantially the following is true: input power =mechanical power). Optionally, due to slight clutch slippage, hydraulic oil can be supplied to supply the transmission 10.

If the volume control valve 16 is completely open (see the illustrated arrows of the directions of rotation of the pump elements 24, 28, 30 according to FIG. 2), due to the described configuration of the summation gearbox 20 the planet carrier 26 of the hydrostatic pump unit 14 is stopped and the drive power is converted exclusively into hydraulic power, driving the hydraulic motor 18 accordingly. Thus, at an accordingly higher (shorter) gear ratio, the sun gear 44 of the hydraulic motor 18 drives the sun gear 46 of the summation gearbox 20 via the hollow shaft 48, and the output occurs via the planetary gears 54, 56 and the ring gear 58 to the output shaft 22 (input power=hydraulic power).

In the case of intermediate positions of the volume control valve 16, the hydrostatic pump 14 operates quasi with slippage, so that the input power can be split in a continuously variable manner between the hydraulic power and the mechanical power, resulting in the appropriate continuously variable gear ratio changes of the summation gearbox 20 and common output via the ring gear 58 and/or the output shaft 22 (input power=mechanical power+hydraulic power).

If the pressure and intake ducts 38, 36 of the hydrostatic pump unit 14 are bypassed by the volume control valve 16, the pump operates without the transfer of input power and thus acts as a separating clutch or starting clutch for the motor vehicle.

In order to establish s fractional connection and/or engage the largest (shortest) gear ratio and/or start driving the motor vehicle, the fluid flow of the hydrostatic pump device 14 is fed to the hydraulic motor 18 in a controlled manner.

In order to implement the slow-driving gear ratio up to “infinite” (standstill of the output shaft 22) of the transmission 10, the hydraulic motor 18 is operated counter to the regular forward direction of rotation of the planet carrier 42 by reversing the fluid flow via the volume control valve 16.

In addition, the planet carrier 42 is held via a brake 60 in order to provide a reverse gear of the transmission 10.

Because in the latter case a fixed gear ratio is given, which is defined by the hydraulic gear ratio between the hydrostatic pump device 14 and the geometry of the summation gearbox 20, the coupling function of the pump device 14 and/or the control of the stalling function of the brake 60 is crucial, as outlined above.

The hydrostatic pump unit 14, the volume control valve 16, and the hydraulic motor can be assembled in one housing (not shown) according to one design embodiment. For this purpose, the center housing part can be a valve housing comprising the integrated pressure and intake ducts 38, 36 and the volume control valve 16. The remaining housing parts at the same time form the encapsulation 34.

1. A power-splitting hydromechanical continuously variable transmission, particularly for motor vehicles, comprising an input shaft, which provides output to a summation gearbox mechanically on the one hand and via a hydrostatic pump unit on the other hand, the summation gear, which is preferably a planetary gearbox, comprising gear elements which are drivably connected at least to the input shaft and an output shaft wherein the hydrostatic pump unit is connected by a first pump element to the input shaft and by a second pump element is mechanically connected to a gear element of the summation gearbox.

2. The transmission according to claim 1, wherein the hydrostatic pump unit is formed by a simple, encapsulated planetary gearbox, the planetary gears of which in interaction with the ring gear and the sun gear thereof form gear pumps, wherein in the housing intake and pressure ducts are formed which communicate with a volume control valve.

3. A transmission according to claim 1 wherein the input shaft drives the sun gear of the planetary gearbox and that the planet carrier thereof provides output for a gear element of the summation gearbox.

4. A transmission according to claim 1 wherein a hydraulic motor, which is preferably disposed axially adjacent to the pump unit, is likewise configured as a closed planetary gearbox, the planetary gears of which in interaction with the ring gear and the sun gear thereof form gear pumps or gear motors, wherein in the pressure ducts and discharge ducts communicating with the volume control valve are provided.

5. The transmission according to claim 4, wherein the ring gear of the planetary gearbox configured as a hydraulic motor is disposed non-rotatably,
that the sun gear thereof is drivably connected to the summation gearbox, and that at least three planetary gears having no planet carriers float between the ring gear and sun gear thereof.

6. A transmission according to claim 1 wherein the summation gearbox is formed of a planetary gear set, comprising a ring gear, a sun gear, and a planet carrier having a plurality of double planetary gears, wherein in each case a radially inner planetary gear meshes with the sun gear and a radially outer planetary gear meshes with the ring gear thereof.

7. The transmission according to claim 6 wherein the planet carrier of the summation gearbox is connected to the planet carrier of the hydrostatic pump unit configured as a planetary gearbox via the planet carrier of the hydrostatic pump unit.

8. The transmission according to claim 6 wherein the sun gear of the summation gearbox is connected to the sun gear of a hydraulic motor configured as a planetary gearbox via a hollow shaft about the first intermediate shaft.

9. A transmission according to claim 6 wherein the ring gear of the summation gearbox is coupled to the output shaft.

10. A transmission according to claim 2 wherein for power-splitting control via the volume control valve the pressure ducts of the hydrostatic pump unit can be varied from completely open to completely closed, and that in addition the intake ducts of the pump unit can be bypassed with the pressure ducts thereof to interrupt a power transfer.

11. A transmission according to claim 1 wherein in order to provide an opposite direction of rotation of the output shaft, the hydraulic motor is driven in the opposite direction by reversing the volume flow, and
that furthermore a planet carrier of the summation gearbox configured as a planetary gearbox is stalled.

12. A transmission according to claim 1 wherein the hydrostatic pump unit at the same time operates the basic supply for the transmission with respect to lubrication, cooling, and the like.
